(19) United States
(12) Patent Application Publication
(10) Pub. No.: US 2007/0100472 A1
(43) Pub. Date: May 3, 2007

(54) System and method for creating serial interface protocols in a process control environment

(75) Inventors: James M. Johnson, Tramore (IE); Paul F. McLaughlin, Ambler, PA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/263,266

(22) Filed: Oct. 31, 2005

(51) Int. Cl. G05B 11/01; G05B 19/42

(52) U.S. Cl. 700/18; 700/86; 700/87

(57) ABSTRACT

A method includes creating a plurality of function blocks. The function blocks are defined by at least one user. The method also includes identifying a plurality of data flows between the function blocks. Each data flow includes at least one of: a flow of data from an output of one of the function blocks and a flow of data into an input of one of the function blocks. The method further includes identifying at least one value for at least one property of one or more of the function blocks. The function blocks, data flows, and at least one property value define a serial interface protocol for communicating over a serial interface. The data flows may be identified by presenting symbols representing the function blocks to the at least one user via a graphical user interface and allowing the at least one user to link inputs and outputs of the symbols.

### CROSS-REFERENCE TO RELATED APPLICATIONS

This application is related to the following patent applications:

Ser. No. 11/175,848 entitled “DETERMINISTIC RUNTIME EXECUTION ENVIRONMENT AND METHOD” filed on Jul. 6, 2005; and

Ser. No. 11/175,703 entitled “APPARATUS AND METHOD FOR DETERMINISTIC GARBAGE COLLECTION OF A HEAP MEMORY” filed on Jul. 6, 2005;

both of which are hereby incorporated by reference.

### TECHNICAL FIELD

This disclosure relates generally to control systems and more specifically to a system and method for creating serial interface protocols in a process control environment.

### BACKGROUND

Processing facilities are typically managed using process control systems. Example processing facilities include manufacturing plants, chemical plants, crude oil refineries, and ore processing plants. Motors, catalytic crackers, valves, and other industrial equipment typically perform actions needed to process materials in the processing facilities. Among other functions, the process control systems often manage the use of the industrial equipment in the processing facilities.

In conventional process control systems, various controllers are often used to control the operation of the industrial equipment in the processing facilities. The controllers could, for example, monitor the operation of the industrial equipment, provide control signals to the industrial equipment, and generate alarms when malfunctions are detected.

Conventional controllers often communicate in the process control systems over serial interfaces. The serial interfaces are typically defined by manufacturers or designers of the conventional controllers. Facility operators who purchase or use the conventional controllers often have no mechanism for creating or defining their own serial interfaces.

### SUMMARY

This disclosure provides a system and method for creating serial interface protocols in a process control environment.

In a first embodiment, a method includes creating a plurality of function blocks. The plurality of function blocks are defined by at least one user. The method also includes identifying a plurality of data flows between the function blocks. Each data flow includes at least one of: a flow of data from an output of one of the function blocks and a flow of data into an input of one of the function blocks. The method further includes identifying at least one value for at least one property of one or more of the function blocks. The function blocks, data flows, and at least one property value define a serial interface protocol for communicating over a serial interface.

In particular embodiments, a controller in a process control system is capable of using the serial interface protocol to communicate over the serial interface, and the serial interface protocol is defined in the controller without requiring any hardware, software, and firmware updates. In other particular embodiments, the plurality of data flows are identified by presenting symbols representing the plurality of function blocks to the at least one user via a graphical user interface and allowing the at least one user to link inputs and outputs of the symbols to define the data flows.

In a second embodiment, an apparatus includes at least one memory capable of storing a plurality of function blocks. The apparatus also includes at least one processor capable of creating the plurality of function blocks, where the plurality of function blocks are defined by at least one user. The at least one processor is also capable of identifying a plurality of data flows between the function blocks. Each data flow includes at least one of: a flow of data from an output of one of the function blocks and a flow of data into an input of one of the function blocks. In addition, the at least one processor is capable of receiving at least one value for at least one property of one or more of the function blocks. The function blocks, data flows, and at least one property value define a serial interface protocol for communicating over a serial interface.

In a third embodiment, a computer program is embodied on a computer readable medium and is operable to be executed by a processor. The computer program includes computer readable program code for creating a plurality of function blocks, where the plurality of function blocks are defined by at least one user. The computer program also includes computer readable program code for identifying a plurality of data flows between the function blocks. Each data flow includes at least one of: a flow of data from an output of one of the function blocks and a flow of data into an input of one of the function blocks. In addition, the computer program includes computer readable program code for assigning at least one value for at least one property of one or more of the function blocks. The function blocks, data flows, and at least one property value define a serial interface protocol for communicating over a serial interface.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to one embodiment of this disclosure;

FIG. 2 illustrates an example execution environment according to one embodiment of this disclosure;

FIG. 3 illustrates an example definition of a function block for use in defining a serial interface protocol according to one embodiment of this disclosure;

FIG. 4 illustrates an example definition of a serial interface protocol according to one embodiment of this disclosure;

FIG. 5 illustrates an example serial interface subsystem according to one embodiment of this disclosure; and

FIG. 6 illustrates an example method for creating serial interface protocols according to one embodiment of this disclosure.

### DETAILED DESCRIPTION

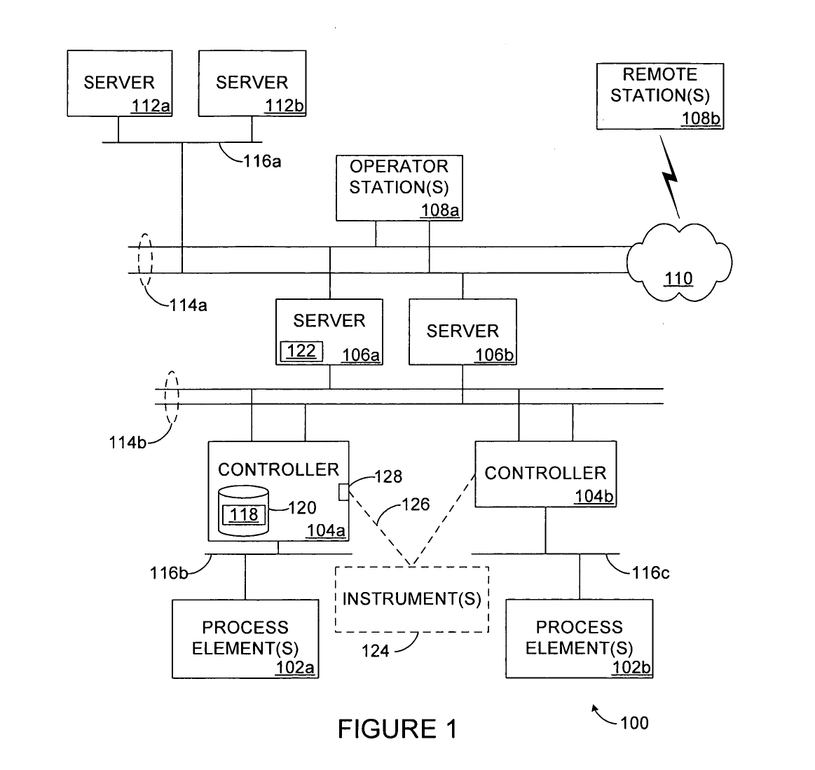

FIG. 1 illustrates an example process control system 100 according to one embodiment of this disclosure.

The embodiment of the process control system 100 shown in FIG. 1 is for illustration only. Other embodiments of the process control system 100 may be used without departing from the scope of this disclosure.

In this example embodiment, the process control system 100 includes one or more process elements 102a-102b. The process elements 102a-102b represent components in a process or production system that may perform any of a wide variety of functions. For example, the process elements 102a-102b could represent motors, catalytic crackers, valves, and other industrial equipment in a production environment. The process elements 102a-102b could represent any other or additional components in any suitable process or production system. Each of the process elements 102a-102b includes any hardware, software, firmware, or combination thereof for performing one or more functions in a process or production system.

Two controllers 104a-104b are coupled to the process elements 102a-102b. The controllers 104a-104b control the operation of the process elements 102a-102b. For example, the controllers 104a-104b could be capable of providing control signals to the process elements 102a-102b periodically. As a particular example, if a process element represents a motor, one of the controllers 104a-104b could provide control information to the motor once every millisecond. Each of the controllers 104a-104b includes any hardware, software, firmware, or combination thereof for controlling one or more of the process elements 102a-102b. The controllers 104a-104b could, for example, include processors of the POWERPC processor family running the GREEN HILLS INTEGRITY operating system or processors of the X86 processor family running a MICROSOFT WINDOWS operating system.

Two servers 106a-106b are coupled to the controllers 104a-104b. The servers 106a-106b perform various functions to support the operation and control of the controllers 104a-104b and the process elements 102a-102b. For example, the servers 106a-106b could log information collected or generated by the controllers 104a-104b, such as status information related to the operation of the process elements 102a-102b. The servers 106a-106b could also execute applications that control the operation of the controllers 104a-104b, thereby controlling the operation of the process elements 102a-102b. In addition, the servers 106a-106b could provide secure access to the controllers 104a-104b. Each of the servers 106a-106b includes any hardware, software, firmware, or combination thereof for providing access to or control of the controllers 104a-104b. The servers 106a-106b could, for example, represent personal computers (such as desktop computers) executing WINDOWS 2000 from MICROSOFT CORPORATION. As another example, the servers 106a-106b could include processors of the POWERPC processor family running the GREEN HILLS INTEGRITY operating system or processors of the X86 processor family running a MICROSOFT WINDOWS operating system.

One or more operator stations 108a-108b are coupled to the servers 106a-106b. The operator stations 108a-108b represent computing or communication devices providing user access to the servers 106a-106b, which could then provide user access to the controllers 104a-104b and the process elements 102a-102b. For example, the operator stations 108a-108b could allow users to review the operational history of the process elements 102a-102b using information collected by the controllers 104a-104b and servers 106a-106b. The operator stations 108a-108b could also allow the users to adjust the operation of the process elements 102a-102b, controllers 104a-104b, or servers 106a-106b. Each of the operator stations 108a-108b includes any hardware, software, firmware, or combination thereof for supporting user access and control of the system 100. The operator stations 108a-108b could, for example, represent personal computers executing WINDOWS 95, WINDOWS 2000, or WINDOWS NT from MICROSOFT CORPORATION.

In this example, at least one of the operator stations 108b is a remote station. The remote station is coupled to the servers 106a-106b through a network 110. The network 110 facilitates communication between various components in the system 100. For example, the network 110 may communicate Internet Protocol (IP) packets, frame relay frames, Asynchronous Transfer Mode (ATM) cells, or other suitable information between network addresses. The network 110 may include one or more local area networks (LANs), metropolitan area networks (MANs), wide area networks (WANs), all or a portion of a global network such as the Internet, or any other communication system or systems at one or more locations.

In this example, the system 100 includes two additional servers 112a-112b. The servers 112a-112b execute various applications to control the overall operation of the system 100. For example, the system 100 could be used in a processing or production plant or other facility, and the servers 112a-112b could execute applications used to control the plant or other facility. As particular examples, the servers 112a-112b could execute applications such as enterprise resource planning (ERP), manufacturing execution system (MES), or any other or additional plant or process control applications. Each of the servers 112a-112b includes any hardware, software, firmware, or combination thereof for controlling the overall operation of the system 100.

As shown in FIG. 1, the system 100 includes various redundant networks 114a-114b and single networks 116a-116c that support communication between components in the system 100. Each of these networks 114a-114b, 116a-116c represents any suitable network or combination of networks facilitating communication between components in the system 100. The networks 114a-114b, 116a-116c could, for example, represent Ethernet networks.

In one aspect of operation, control processes are implemented by the controllers 104a-104b to control the operation of the process elements 102a-102b. In this example, the control processes may be constructed using function blocks 118. The function blocks 118 represent executable software objects that perform specific tasks. A user (such as a control or process engineer) may select and link particular function blocks 118 to define a control process. Each of the controllers 104a-104b then implement the defined control process using the selected function blocks 118. The function blocks 118 may be stored in any suitable memory 120, such as a database or other repository within or accessible by the controller.

In some embodiments, the function blocks 118 are represented graphically by symbols (such as rectangles with specified inputs and outputs), and control processes are graphically constructed using a process builder 122. The process builder 122 provides a graphical user interface that allows a user to create or edit control processes using the graphical symbols representing the function blocks 118. For example, the process builder 122 may allow the user to select particular function blocks 118, which presents the graphical symbols representing those selected function blocks 118 to the user. The user may then link the inputs and outputs of the symbols representing the selected function blocks 118, thereby defining data flows between the function blocks 118. The defined process is then executed in the controllers 104a-104b using the selected function blocks 118. In this way, the user may graphically create a control process using the function blocks 118, possibly without typing any computer code at all. The process builder 122 includes any hardware, software, firmware, or combination thereof for graphically creating or editing control processes. The process builder 122 could, for example, represent a CONTROL BUILDER application from HONEYWELL INTERNATIONAL, INC. Users, however, could use any other or additional techniques to define a control process.

In this example embodiment, the controllers 104a-104b communicate with one or more elements of the process control system 100 using serial interfaces. For example, each of the controllers 104a-104b could be coupled to and communicate with one or more instruments 124 using one or more serial interfaces 126. The controllers 104a-104b are coupled to the one or more serial interfaces 126 by one or more serial ports 128. The instruments 124 could represent any suitable device(s) or component(s) capable of performing one or more functions in the process control system 100. The instruments 124 could, for example, represent weight scales, analyzers, and programmable logic controllers (PLCs). As particular examples, the instruments 124 could represent devices supporting a MODBUS serial protocol, low speed serial devices supporting a direction connection using MODBUS or similar protocol, or low speed serial devices using the Process Manager (PM) Serial Interface (SI) Field Termination Assembly (FTA) from HONEYWELL INTERNATIONAL, INC.

The controllers 104a-104b support user-authoring of serial interface protocols for use in the process control system 100. In other words, the controllers 104a-104b allow users to define custom or proprietary serial interface protocols for use in the process control system 100. In particular, the controllers 104a-104b allow the users to create or edit the serial interface protocols using the function blocks 118. For example, various function blocks 118 could be created and linked to define how a particular serial interface protocol should operate. These function blocks 118 could then be incorporated into or invoked by control processes and other applications, allowing the control processes or other applications to use the defined serial interface protocol. Additional details of user-authoring of serial interface protocols are provided below.

In this way, users can define any suitable serial interface protocol for use in one or more process control systems. This may allow operators of the process control system 100 to create their own serial interface protocol(s), and the operators may not be limited to the serial interface protocols provided by manufacturers or designers of the controllers 104a-104b. Also, this may allow more suitable or more appropriate serial interface protocols to be created and used for a particular process control system. This may further allow the controllers 104a-104b to interact with a larger number or variety of instruments 124 or other components. This is because users can create the appropriate serial interface protocol to communicate with a particular instrument 124 or other component, even if the controller manufacturer or designer did not provide the appropriate serial interface protocol.

The users who create or edit serial interface protocols could represent any suitable users or other personnel involved with a process control system. For example, end users or other personnel of a processing facility could implement the necessary serial interface protocols for that processing facility. As another example, development engineers or other personnel of a controller manufacturer or designer could implement various serial interface protocols for inclusion with or installation in the controllers.

In some embodiments, at least one of the controllers 104a-104b executes, supports, or otherwise provides access to an execution environment. The execution environment provides support for various features that managed applications may use during execution. As examples, the execution environment could provide support for mathematical functions, input/output functions, communication functions, and memory management functions. The phrase “managed application” refers to an application executed in the execution environment, where the execution of the application is managed by the execution environment.

Managed applications could include real-time or other applications used to control the process elements 102a-102b in the system 100, including applications that use one or more serial interface protocols defined using the function blocks 118.

In particular embodiments, the execution environment is deterministic. A deterministic execution environment is an execution environment whose behavior is predictable or that can be precisely specified. The execution environment could be implemented in any suitable manner, such as by using NET programming based on the CLI specification as ratified by ECMA-335 and supporting both the Kernel and Compact profiles.

Although FIG. 1 illustrates one example of a process control system 100, various changes may be made to FIG. 1. For example, a control system could include any number of process elements, controllers, servers, and operator stations. Also, although shown as residing in the server 106a, the process builder 122 may be located in any suitable location(s), such as on multiple servers, one or more of the controllers 104a-104b, or one or more of the operator stations 108a-108b. In addition, FIG. 1 illustrates one operational environment in which user-authoring of serial interface protocols may be supported. User-authoring of serial interface protocols could be supported in any other suitable device or system.

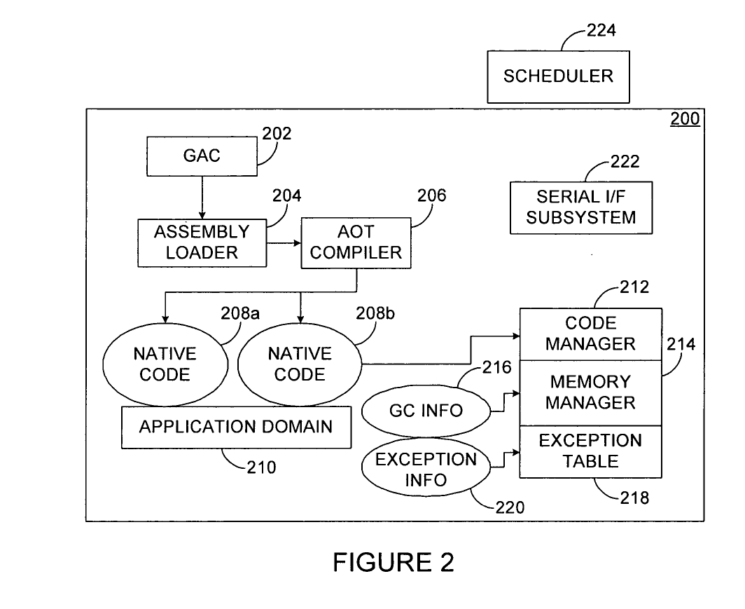

FIG. 2 illustrates an example execution environment 200 according to one embodiment of this disclosure. The embodiment of the execution environment 200 shown in FIG. 2 is for illustration only. Other embodiments of the execution environment could be used without departing from the scope of this disclosure. Also, the execution environment 200 shown in FIG. 2 could be implemented in the controllers 104a-104b of FIG. 1, although the execution environment 200 could be used in any other suitable device or system.

In this example embodiment, the execution environment 200 includes a global assembly cache (GAC) 202.

The global assembly cache 202 represents a memory capable of storing different assembly code programs to be executed in the execution environment 200. The assembly code programs could represent the managed applications to be executed in the execution environment 200. As an example, the global assembly cache 202 could store an assembly code program capable of controlling one or more of the process elements 102a-102b of FIG. 1. The global assembly cache 202 could store multiple assembly code programs and/or different versions of the same assembly code program. The global assembly cache 202 represents any suitable storage and retrieval device or devices.

An assembly loader 204 loads assembly code into the execution environment 200 for execution. For example, the assembly loader 204 may retrieve new assembly code downloaded by a user into the global assembly cache 202. The assembly loader 204 may then load the identified assembly code into a compiler for compilation and use in the execution environment 200. The assembly loader 204 includes any hardware, software, firmware, or combination thereof for loading assembly code for compilation. The assembly loader 204 could, for example, represent a software thread executed in the background of the execution environment 200.

An ahead-of-time (AOT) compiler 206 compiles the assembly code loaded by the assembly loader 204. The AOT compiler 206 represents a load-time compiler that compiles assembly code when the assembly code is loaded. For example, the AOT compiler 206 may convert assembly code from an intermediate language to native executable code capable of being executed in the execution environment 200.

Also, the AOT compiler 206 could insert instructions into the native executable code to ensure proper execution of the code in the execution environment 200. The AOT compiler 206 includes any hardware, software, firmware, or combination thereof for compiling assembly code. The AOT compiler 206 could, for example, represent a software thread executed in the background of the execution environment 200.

The AOT compiler 206 produces native executable code, such as native executable codes 208a-208b. The native executable codes 208a-208b represent executable code capable of being executed in the execution environment 200.

The native executable codes 208a-208b could provide any suitable functionality in the execution environment 200, such as providing control of one or more process elements 102a-102b of FIG. 1. The native executable codes 208a-208b could provide any other or additional functionality in the execution environment 200.

One or more application domains 210 represent the domains in which one or more managed applications (such as the applications implemented by the native executable codes 208a-208b) are executed in the execution domain 200. Each application domain 210 represents any suitable domain for executing one or more managed applications. While shown as a single application domain 210 in FIG. 2, multiple application domains 210 could be used.

The assembly codes and native executable codes in the execution environment 200 are managed by a code manager 212. For example, the code manager 212 may control the loading and unloading of assembly code in the execution environment 200. As a particular example, the code manager 212 could receive a command from a user or managed application instructing the execution environment 200 to load an assembly code program, and the code manager 212 could cause the assembly loader 204 to load the assembly code into the AOT compiler 206 for compilation. The code manager 212 could also receive a command from a user or managed application instructing the execution environment 200 to unload an assembly code program, and the code manager 212 could unload the native executable code associated with the identified assembly code from the application domain 210. The code manager 212 includes any hardware, software, firmware, or combination thereof for managing assembly code and/or compiled code used in the execution environment 200. The code manager 212 could, for example, represent a software thread executed in the background of the execution environment 200.

The execution environment 200 also includes a memory manager 214 that manages the use of a memory. For example, the memory manager 214 could allocate blocks of memory to managed applications being executed in the application domain 210. The memory manager 214 could also use garbage collection information 216 to release blocks of memory that are no longer being used by the managed applications. The garbage collection information 216 could, for example, be generated by a garbage collection process provided by the memory manager 214 and executed in the background of the execution environment 200. In addition, the memory manager 214 could support a defragmentation process for the memory. The defragmentation process could be used to combine unused blocks of memory into larger blocks. The memory manager 214 includes any hardware, software, firmware, or combination thereof for managing a memory, such as a deterministic memory manager. The memory manager 214 could, for example, represent a software thread executed in the background of the execution environment 200.

The execution environment 200 further includes an exception table 218, which stores exception information 220. The exception information 220 identifies various problems experienced in the execution environment 200. Example problems could include attempting to load assembly code that does not exist in an explicitly specified location or in the global assembly cache 202, an error during compilation of loaded assembly code, or attempting to unload assembly code not previously loaded. An application or process being executed in the execution environment 200 could generate an exception identifying a detected problem. The exception is identified by the exception information 220, which is stored in the exception table 218 for later use (such as during debugging) or for use by the application or process for automatic recovery at runtime.

In addition, the execution environment 200 includes a serial interface subsystem 222. The serial interface subsystem 222 supports the serial communication of data to or the serial reception of data from one or more components. For example, the serial interface subsystem 222 could allow a controller 104a implementing the execution environment 200 to communicate with a serial data device, such as an instrument 124. As described above, the serial interface subsystem 222 could support one or more user-defined serial interface protocols. The user-defined serial interface protocols could be specified, for example, via the creation and linking of various function blocks 118.

The serial interface subsystem 222 includes any hardware, software, firmware, or combination thereof for supporting the use of one or more user-defined serial interface protocols. The serial interface subsystem 222 could, for example, include one or more physical serial ports and a software thread executed in the background of the execution environment 200. In some embodiments, the execution environment 200 is implemented using embedded .NET, which is often denoted as “(E).NET”. In particular embodiments, the serial interface subsystem 222 is based on (E).NET and forms part of an integrated .NET tools and control environment for user-authoring of serial interface protocols, as well as user-authoring of control processes and other applications that use the serial interface protocols. Although described as forming part of the execution environment 200 in the controllers 104a-104b, the serial interface subsystem 222 could form part of any other suitable device or system or represent a stand-alone component.

A scheduler 224 is used to schedule execution of the managed applications, such as the native executable codes 208a-208b. The scheduler 224 may also be used to schedule execution of the background tasks in the execution environment 200. The background tasks include, among other things, providing memory management, assembly loading and unloading, and assembly compilation. For example, the scheduler 224 could support time slicing to allow multiple threads to be executed, where the threads represent the background tasks and the managed applications. The scheduler 224 includes any hardware, software, firmware, or combination thereof for scheduling the execution of applications and other tasks.

In some embodiments, the various components shown in FIG. 2 operate over a platform/operating system abstraction layer. The platform/operating system abstraction layer logically separates the execution environment 200 from the underlying hardware platform or operating system. In this way, the execution environment 200 may be used with different hardware platforms and operating systems without requiring the execution environment 200 to be specifically designed for a particular hardware platform or operating system.

Although FIG. 2 illustrates one example of an execution environment 200, various changes may be made to FIG. 2. For example, the functional division shown in FIG. 2 is for illustration only. Various components in FIG. 2 could be combined or omitted and additional components could be added according to particular needs.

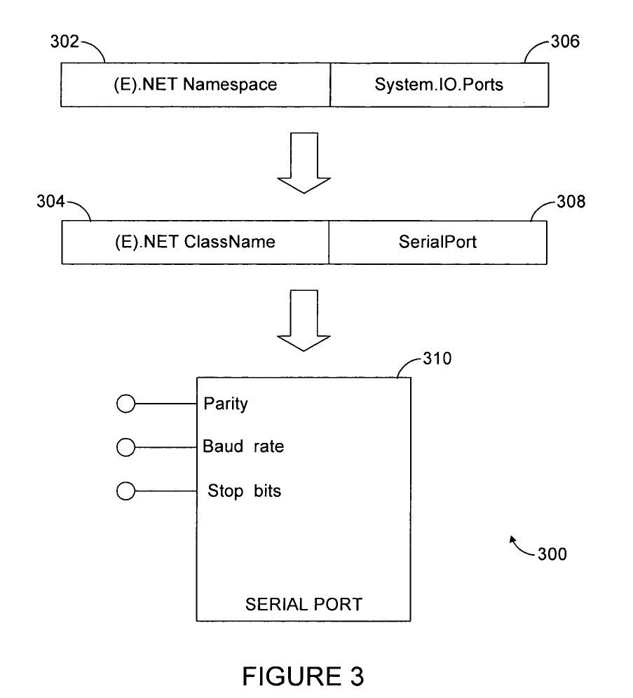

FIG. 3 illustrates an example definition 300 of a function block for use in defining a serial interface protocol according to one embodiment of this disclosure. The definition 300 of the function block shown in FIG. 3 is for illustration only. Function blocks could be defined in any other suitable manner without departing from the scope of this disclosure. Also, for ease of explanation, the definition 300 of the function block shown in FIG. 3 is described as occurring within the serial interface subsystem 222 of FIG. 2 in the controller 104a of FIG. 1, although the definition 300 of the function block could occur in any other suitable device or system.

As noted above, the serial interface subsystem 222 may be based on or implemented using (E).NET. In this example, the serial interface subsystem 222 could operate within an (E).NET namespace 302. The (E).NET namespace 302 generally represents different collections of classes 304 available for use within a .NET framework. For example, the (E).NET namespace 302 may include classes 304 that support diagnostics, debugging, security, and electronic mail functions (just to name a few). In particular embodiments, the classes 304 could be abstracted in a manner that is specific to the particular organization using the serial interface subsystem 222.

In this example, the (E).NET namespace 302 includes a serial port namespace 306. The serial port namespace 306 is denoted “System.IO.Ports” and represents a namespace that contains various classes for controlling serial ports. In particular, the serial port namespace 306 includes a serial port class 308 denoted “SerialPort”. The serial port class 308 provides a framework for synchronous and event-driven input/output (I/O), access to pin and break states, and access to serial driver properties. As a particular example, the serial port class 308 may be used to wrap a “Stream” object, which allows a serial port to be accessed by classes that communicate using streams.

The serial port class 308 could be encapsulated to form a function block 310. The function block 310 represents a function block that provides access to a physical serial port (such as port 128). Properties of the function block 310 may define basic operational parameters of the serial port, thereby defining how access to the physical serial port occurs. In this example, the properties of the function block 310 represent the baud rate, parity, and stop bit settings to be used for a serial interface protocol. Within the function block 310, the function block 310 could contain logic supporting various functions needed to operate the physical serial port, such as open, close, read, and write.

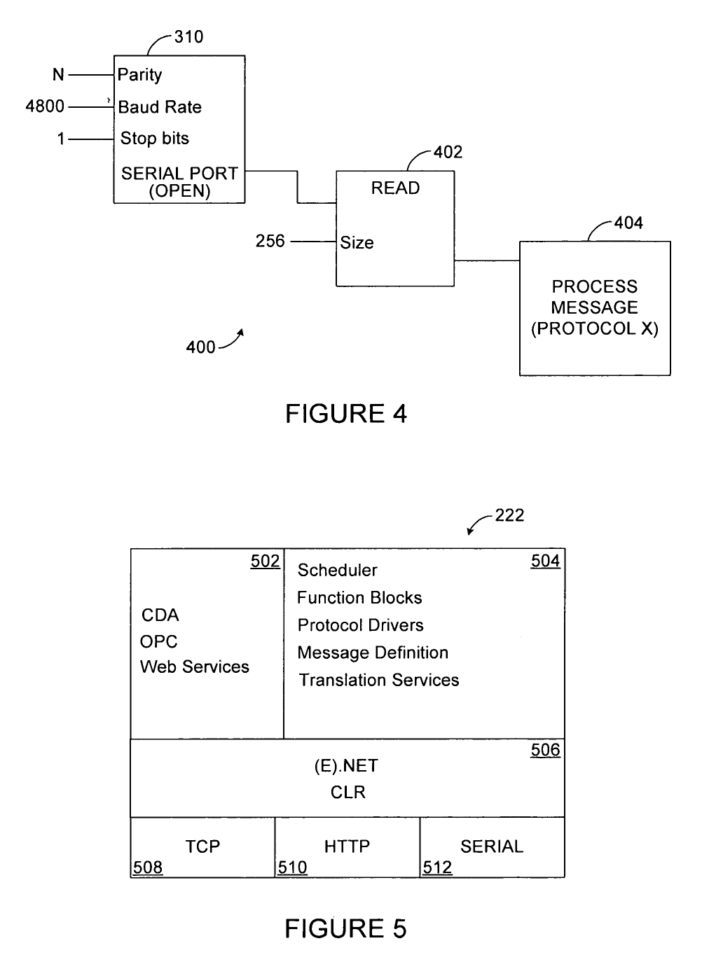

The function block 310 shown in FIG. 3 may be incorporated or packaged into a serial interface protocol definition. One example of a serial interface protocol definition is shown in FIG. 4, which is described below.

Although FIG. 3 illustrates one example of a definition 300 of a function block for use in defining a serial interface protocol, various changes may be made to FIG. 3. For example, the function block 310 shown in FIG. 3 is for illustration only. Any other or additional function blocks could be created for use in defining a serial interface protocol. Also, the function block 310 could include any suitable number and type of properties. In addition, any other or additional techniques could be used to create a function block for use in defining a serial interface protocol.

FIG. 4 illustrates an example definition 400 of a serial interface protocol according to one embodiment of this disclosure. In particular, FIG. 4 illustrates an example definition 400 of one function forming part of a serial interface protocol. The definition 400 of the serial interface protocol shown in FIG. 4 is for illustration only. Serial interface protocols could be defined in any other suitable manner without departing from the scope of this disclosure. Also, for ease of explanation, the definition 400 of the serial interface protocol shown in FIG. 4 is described as occurring within the serial interface subsystem 222 of FIG. 2 in the controller 104a of FIG. 1, although the definition 400 of the serial interface protocol could occur in any other suitable device or system.

As shown in FIG. 4, the serial interface protocol definition 400 includes the function block 310 of FIG. 3. In this example, the function block 310 has been configured to perform an open operation for a physical serial port. The function block 310 has also been configured to operate using a parity of N, a baud rate of 4800, and one stop bit. This defines the physical port or channel characteristics over which this particular serial interface protocol will communicate.

A second function block 402 implements a read operation to read data from the physical serial port. In this example, the function block 402 has a size property defining the amount of data to be read from the serial port. In this case, the function block 402 has been configured to read 256 bytes. The serial interface protocol definition 400 further includes a third function block 404. The third function block 404 implements the logic required to process the data received via the physical serial port.

As shown in this example, starting with .NET as the control basis, function blocks may be created to add services to express communication protocols and to express semantic awareness of the serial data. In this example, the function blocks 310 and 402 define how data is physically retrieved over a serial interface, and the function block 404 defines how that data is processed.

The serial interface protocol definition 400 shown in FIG. 4 represents a simplified version of how a serial interface protocol may be defined using function blocks. In particular, FIG. 4 may illustrate how a serial interface protocol may be defined without showing an exact implementation of a serial interface protocol. A specific implementation of a serial interface protocol could include function blocks supporting functions such as synchronous or asynchronous communication, simplex or duplex communication, common error reporting, data logging, and security. These function blocks could be implemented as part of the function block 404.

Semantic awareness of the serial data could be achieved in several ways. For example, semantic awareness could be achieved by coding it directly into the serial interface protocol definition 400, such as in the function block 404. As another example, semantic awareness could be achieved by applying MetaData behavior, which could be shared across a number of serial interface protocols. As a particular example, .NET extensible Markup Language (XML) services could be used to describe the metadata. The .NET XML services could also be used to transform serial data to and from a format used by a specific endpoint (the device communicating with the serial interface subsystem 222 over a serial interface) and a common format suitable for class reuse in the serial interface subsystem 222.

Serial interface protocol definitions 400 could be used to support any suitable protocols and behaviors related to the use of a serial interface. For example, serial interface protocol definitions 400 could support protocols such as the MODBUS, 200100, SCL, RK512, R3964, and custom protocols. Serial interface protocol definitions 400 could also support simplex, duplex, synchronous, and asynchronous communications. In addition, serial interface protocol definitions 400 could support throttling, error handling, diagnostics, security, and metadata operations.

When properly designed and packaged as a complete serial interface protocol definition 400, a serial interface protocol may be available to programmers using textual based custom function blocks, graphical function blocks, or in any other suitable manner. Also, serial interface protocol definitions 400 may be developed and updated dynamically. New serial interface protocols could be developed and added as needed without affecting the operation of the controllers 104a-104b. In addition, the serial interface protocols could be represented as loadable libraries, which could be added to the controllers 104a-104b as needed. This may allow end-point customization, upgrades, and other changes to serial interface protocols without requiring hardware, software, or firmware updates.

Although FIG. 4 illustrates one example of a definition 400 of a serial interface protocol, various changes may be made to FIG. 4. For example, the serial interface protocol definition 400 could include any number of function blocks implementing any suitable logic required to support a serial interface protocol.

FIG. 5 illustrates an example serial interface subsystem 222 according to one embodiment of this disclosure. The embodiment of the serial interface subsystem 222 shown in FIG. 5 is for illustration only. Other embodiments of the serial interface subsystem 222 may be used without departing from the scope of this disclosure. Also, for ease of explanation, the serial interface subsystem 222 is described as being implemented within the controller 104a of FIG. 1. The serial interface subsystem 222 could be used in any other suitable device or system or represent a stand-alone component.

In this example, the serial interface subsystem 222 includes an interface 502 for communications with other components of the controller 104a. In this example, the interface 502 represents a Common Data Access (CDA) interface from HONEYWELL INTERNATIONAL INC. or an Object Linking and Embedding (OLE) for Process Control (OPC) interface. The CDA interface could support functions such as named parameter access, peer-to-peer publishing, event recovery, and participation in a Fault Tolerant Ethernet (FTE) network. The OPC interface could support the OPC XML Data Access (DA) standard or web services.

The serial interface subsystem 222 also includes or otherwise has access to various functions 504. In this example, the serial interface subsystem 222 includes or has access to the scheduler 224 and to one or more function blocks, such as function blocks 118. As particular examples, the function blocks 118 could implement a serial interface protocol, such as by implementing drivers for sending and receiving data over a serial interface, defining a format for data messages sent and received over the serial interface, and providing translation functions to translate data sent and received over the serial interface into appropriate formats.

The serial interface subsystem 222 further includes or has access to an execution environment 506. The execution environment 506 could, for example, represent an (E).NET execution environment (such as the execution environment 200 of FIG. 2) or a Common Language Runtime (CLR) execution environment (a multi-language execution environment).

Protocol layers 508-510 support communications using the Transmission Control Protocol (TCP) and the Hypertext Transfer Protocol (HTTP), respectively. This may be useful, for example, for backend communications using CDA, OPC DA XML, or web services. A protocol layer 512 represents a serial protocol layer, which may represent any protocol implemented within the serial interface subsystem 222 by a manufacturer or designer of the controller 104a or by an end user of the controller 104a.

Although FIG. 5 illustrates one example of a serial interface subsystem 222, various changes may be made to FIG. 5. For example, the serial interface subsystem 222 could include any other or additional interfaces 502 and any other or additional protocol layers 508-512.

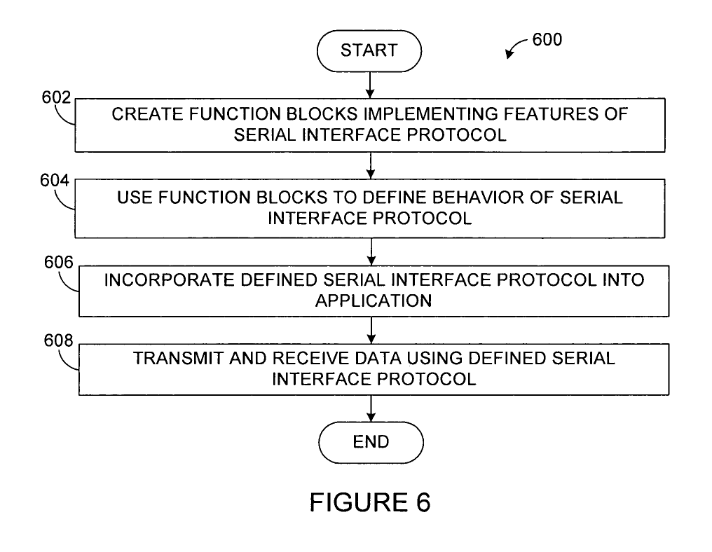

FIG. 6 illustrates an example method 600 for creating serial interface protocols according to one embodiment of this disclosure. For ease of explanation, the method 600 is described with respect to the controller 104a in the process control system 100 of FIG. 1. The method 600 could be used in any other suitable device or system.

The controller 104a allows a user to create function blocks 118 implementing various features of a serial interface protocol at step 602. This may include, for example, the controller 104a allowing the user to create function blocks defining the baud rate, parity, and stop bit settings to be used for a serial interface protocol. This could also include the controller 104a allowing the user to create function blocks supporting synchronous or asynchronous communication, simplex or duplex communication, common error reporting, data logging, and security functions for the serial interface protocol.

The controller 104a allows the user to define the behavior of the serial interface protocol at step 604. This may include, for example, the controller 104a allowing the user to create a serial interface protocol definition 400 by linking various ones of the function blocks. The links define data flows between various ones of the function blocks.

At this point, the user has specified the function blocks and the interactions between the function blocks for the serial interface protocol. As a result, the user has successfully defined the serial interface protocol, and the protocol may be used by the controller 104a. In this example, the defined serial interface protocol is incorporated into an application at step 606. This may include, for example, the user incorporating the serial interface protocol definition 400 into a control process or other application via the process builder 122.

The controller 104a then transmits and receives data using the defined serial interface protocol at step 608. This may include, for example, the controller 104a using the linked function blocks to implement various functions supporting the transmission and reception of data using the defined serial interface protocol. This may occur during execution of the control process or other application.

Although FIG. 6 illustrates one example of a method 600 for creating serial interface protocols, various changes may be made to FIG. 6. For example, if all of the function blocks needed to implement a serial interface protocol are already available, step 602 may be skipped. Also, step 602 could include editing existing function blocks rather than creating new function blocks.

It may be advantageous to set forth definitions of certain words and phrases used throughout this patent document. The term “couple” and its derivatives refer to any direct or indirect communication between two or more elements, whether or not those elements are in physical contact with one another. The term “application” refers to one or more computer programs, sets of instructions, procedures, functions, objects, classes, instances, or related data adapted for implementation in a suitable computer language. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
creating a plurality of function blocks, the plurality of function blocks defined by at least one user;
identifying a plurality of data flows between the function blocks, each data flow comprising at least one of:
a flow of data from an output of one of the function blocks and a flow of data into an input of one of the function blocks; and
identifying at least one value for at least one property of one or more of the function blocks;
wherein the function blocks, data flows, and at least one property value define a serial interface protocol for communicating over a serial interface.

2. The method of claim 1, further comprising using the function blocks, data flows, and at least one property value to at least one of:
transmit data over the serial interface using the defined serial interface protocol; and
receive data over the serial interface using the defined serial interface protocol.

3. The method of claim 1, wherein identifying the plurality of data flows comprises:
presenting symbols representing the plurality of function blocks to the at least one user via a graphical user interface; and
allowing the at least one user to link inputs and outputs of the symbols to define the data flows.

4. The method of claim 1, wherein a first of the function blocks is associated with properties defining a baud rate, a parity, and a stop bit setting of the serial interface protocol.

5. The method of claim 4, wherein a second of the function blocks is associated with a property defining a quantity of data to be read, and wherein the data to be read is received over the serial interface and provided to the second function block via the first function block.

6. The method of claim 5, wherein a third of the function blocks implements logic for processing the data read by the second function block.

7. The method of claim 1, further comprising executing one or more applications, the one or more applications capable of using the serial interface protocol during execution.

8. The method of claim 1, wherein:
a controller in a process control system is capable of using the serial interface protocol to communicate over the serial interface; and
the serial interface protocol is defined in the controller without requiring any hardware, software, and firmware updates to the controller.

9. The method of claim 1, wherein the at least one user comprises at least one end user of a controller operating in a process control system.

10. An apparatus, comprising:
at least one memory capable of storing a plurality of function blocks; and
at least one processor capable of:
creating the plurality of function blocks, the plurality of function blocks defined by at least one user;
identifying a plurality of data flows between the function blocks, each data flow comprising at least one of: a flow of data from an output of one of the function blocks and a flow of data into an input of one of the function blocks; and
receiving at least one value for at least one property of one or more of the function blocks;
wherein the function blocks, data flows, and at least one property value define a serial interface protocol for communicating over a serial interface.

11. The apparatus of claim 10, wherein the at least one processor is capable of using the function blocks, data flows, and at least one property value to at least one of:
transmit data over the serial interface using the defined serial interface protocol; and
receive data over the serial interface using the defined serial interface protocol.

12. The apparatus of claim 10, wherein the at least one processor is capable of identifying the plurality of data flows by:
presenting symbols representing the plurality of function blocks to the at least one user via a graphical user interface; and
allowing the at least one user to link inputs and outputs of the symbols to define the data flows.

13. The apparatus of claim 10, wherein a first of the function blocks is associated with properties defining a baud rate, a parity, and a stop bit setting of the serial interface protocol.

14. The apparatus of claim 13, wherein a second of the function blocks is associated with a property defining a quantity of data to be read, and wherein the data to be read is received over the serial interface and provided to the second function block via the first function block.

15. The apparatus of claim 14, wherein a third of the function blocks implements logic for processing the data read by the second function block.

16. The apparatus of claim 10, wherein the at least one processor is further capable of executing one or more applications, the one or more applications capable of using the serial interface protocol during execution.

17. A computer program embodied on a computer readable medium and operable to be executed by a processor, the computer program comprising computer readable program code for:
creating a plurality of function blocks, the plurality of function blocks defined by at least one user;
identifying a plurality of data flows between the function blocks, each data flow comprising at least one of:
a flow of data from an output of one of the function blocks and a flow of data into an input of one of the function blocks; and
assigning at least one value to at least one property of one or more of the function blocks;
wherein the function blocks, data flows, and at least one property value define a serial interface protocol for communicating over a serial interface.

18. The computer program of claim 17, wherein the computer readable program code for identifying the plurality of data flows comprises computer readable program code for:
presenting symbols representing the plurality of function blocks to the at least one user via a graphical user interface; and
allowing the at least one user to link inputs and outputs of the symbols to define the data flows.

19. The computer program of claim 17, wherein:
a first of the function blocks is associated with properties defining a baud rate, a parity, and a stop bit setting of the serial interface protocol;
a second of the function blocks is associated with a property defining a quantity of data to be read, wherein the data to be read is received over the serial interface and provided to the second function block via the first function block; and
a third of the function blocks implements logic for processing the data read by the second function block.

20. The computer program of claim 17, further comprising computer readable program code for communicating over the serial interface using the serial interface protocol.
